(19) United States
(12) Patent Application Publication
(10) Pub. No.: US 2011/0067622 A1
(43) Pub. Date: Mar. 24, 2011

(54) Non-Adhesive Screen Target

(76) Inventor: BRIAN CHARLES HARDING, Boulder Creek, CA (US)

(21) Appl. No.: 12/885,261

(22) Filed: Sep. 17, 2010

Related U.S. Application Data
(60) Provisional application No. 61/243,983, filed on Sep. 18, 2009.

(51) Int. Cl. G01D 13/00

(52) U.S. Cl. 116/200

(57) ABSTRACT

In accordance with one or more embodiments use one or more non-adhesive materials to create, a graphical, or shape oriented reference point, or points that allow the game player, or players to quickly acquire visually defined areas (FIG. 3A, FIG. 3B). This can improve accuracy, performance or game play in general by, providing a appropriately designed non-destructive reference point to use while the game (FIG. 1), software application or presentation is viewed on the screen behind it. Non-Adhesive screen position indicators can be stacked (FIG. 2) to create custom shapes and designs. Using non-adhesive material to create the Non-Adhesive screen position indicators insures the television, monitor, display screen or similar device will not be damaged.

### CROSS-REFERENCE TO RELATED APPLICATIONS

This application claims the benefit of PPA Ser. No. 61/243,983, filed 2009 Sep. 18 by the present inventor, which is incorporated by reference.

### BACKGROUND—PRIOR ART

No prior art was found.

### Previously:

One or more embodiments relate to Video Game play. Garners can easily become distracted by screen activity, loud noises and other debilitating influences, causing players to lose focus of the target or goal, adversely affecting players' accuracy and performance. To increase performance and accuracy garners in the past would use a small piece of tape, adhesive stickers, putty, or a marking pen to make a reference point at the appropriate point on the screen. These were usually homemade, poorly designed, and would only work one time before they were destroyed. Removing them left behind adhesive residue and/or ink on the screen and was not suitable for newer plastic screens because they would leave a stain or smudge on the screen where it had been placed and sometime destroy the area of the screen it was applied to.

### Advantages:

Thus several advantages of one or more aspects are listed below:

(1) Other advantages of one or more aspects are safe to apply to any television, monitor, display screen or similar device because of its non-adhesive nature.
(2) Other advantages of one or more aspects are Partial alleviation of effects from debilitating influences during video game play.
(3) Other advantages of one or more aspects are improved accuracy, improved performance and improved overall precision in game play
(4) Other advantages of one or more aspects are that the target graphic or shape can be custom designed to meet the requirements of the game, software application or presentation.
(5) Other advantages of one or more aspects are that it can act as learning tool helping by indicating choices on the video screen during presentations or interactive learning games and interactive learning applications.
(6) Other advantages of one or more aspects are it is reusable

### SUMMARY

In accordance with one or more embodiments use the Non-Adhesive screen position indicator to physically mark a location on the screen of a television, monitor, display or similar device with a appropriate shape or graphic with safe material as to not damage the surface it was intended to be applied to, providing a reference point to use while the game, software application or presentation is viewed on the screen behind it.

### DRAWINGS—FIGURES

FIG. 1 Front view of several design examples of a first embodiment of my Non-Adhesive screen position indicator.

FIG. 2 Isometric view of stacking individual designs of a first embodiment of my Non-Adhesive screen position indicator.

FIGS. 3A to 3B Isometric views of one application of a first embodiment of my Non-Adhesive screen position indicator.

### DETAILED DESCRIPTION

### First Embodiment

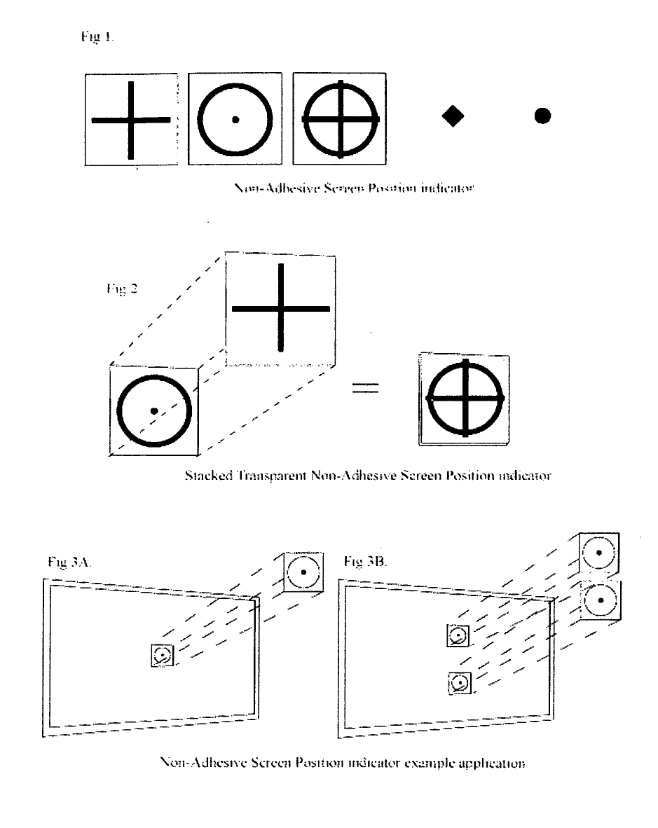

### FIG. 1, FIG. 2, FIG. 3A, FIG. 3B

(FIG. 1) One embodiment is illustrated in (FIG. 1) a front view of 5 versions of my Non-Adhesive screen position indicator. Each measures from ⅛ inches×⅛ inches to 1½ inches×1½ inches, and is made by rendering a graphic on, or cutting a custom shape from non-adhesive material including but not limited to static cling plastic, moisture clinging plastic or suction cups, designed according to the requirements of the game it was designed for.

(FIG. 2) shows how stacking two or more Non-Adhesive screen position indicators (FIG. 1) can create a new design.

(FIG. 3A to 3B) show example applications of my first embodiment on the screen of a television, monitor, display or similar device (FIG. 1, FIG. 2).

### OPERATION

### First Embodiment

### (FIGS. 1, FIG. 2, FIG. 3A, FIG. 3B)

Non-Adhesive screen position indicators (FIG. 1) as used in this embodiment operate as a reference point for aiming while playing video game types including but not limited to first person perspective shooter video games, third person perspective shooter games, and first person simulator games. This type of game tends to use one point of the physical screen (usually center stage) (FIG. 3A) as the impact point for weapons fire. Because of movement on the screen the video game gives you the illusion of moving around looking around, but in general terms your weapons all fire at the same position on the screen. The Non-Adhesive screen position indicators sits at that position and as the game moves in the background the Non-Adhesive screen position indicators sits safely and non-destructively at the same stationary position, allowing video game players to filter out distractions created within the actions and/or effects on the screen. This allows players to acquire targets they normally would not be able to acquire because the Non-Adhesive screen position indicators is showing them where to shoot even if the game is attempting to deceive the player or players by removing or hiding the aiming reticle.

### CONCLUSION, RAMIFICATIONS, AND SCOPE

Accordingly the reader will see that, according to one embodiment of the invention, I have provided several advantages of the Non-Adhesive screen position indicators. One or more aspects are partial alleviation of effects from debilitating influences during video game play, improved accuracy, improved performance and improved overall precision in game play, by using my Non-Adhesive screen position indicators to physically mark a location on the screen of a television, monitor, display or similar device with a safe non-adhesive material as not to damage the surface it is applied to. This provides a non-destructive, appropriately designed reference point to use while the game, is viewed on the screen behind it.

While the above description contains many specificities, these should not be construed as limitations on the scope of any embodiment, but as exemplifications of various embodiments thereof. Many other ramifications and variations are possible within the teachings of the various embodiments. For example, one embodiment of the invention can act as learning tool helping by indicating choices on the video screen during presentations or interactive learning games and interactive learning applications by providing a reference point on the screen of a television, monitor, display or similar device with a safe non-adhesive material as not to damage the surface it is applied to, providing a appropriately designed reference point to use while the game, software application or presentation is viewed on the screen behind it.

Thus the scope should be determined by the appended claims and their legal equivalents, and not by the examples given.

1. A non-adhesive screen position indicator comprising:
(a) Non-Adhesive material used to create or depict said graphic or shape, applied to improve visual recognition by physically marking a location on said television, monitor, display or related device.
(b) Graphic or shape designed to assist in visual recognition and indication of one or more locations on the screen of said television, monitor, display or related device.
